(19) United States
(12) Patent Application Publication
(10) Pub. No.: US 2026/0092635 A1
(43) Pub. Date: Apr. 2, 2026

(54) MOVEMENT CONTROL LOCKING MECHANISM

(71) Applicant: Raytheon Company, Tewksbury, MA (US)

(72) Inventors: Timothy E. Sanborn, Rye, NH (US); Steven P. Kemp, Boxborough, MA (US)

(21) Appl. No.: 18/904,795

(22) Filed: Oct. 2, 2024

(51) Int. Cl. F16F 15/02

(52) U.S. Cl. CPC F16F 15/02; F16F 2230/0041

(57) ABSTRACT

A workpiece movement control system that confines a workpiece body with a support plate with a movement locking mechanism. The movement locking mechanism includes a locking shaft that extends through at least one footing linkage. The at least one footing linkage includes a bracing fastener rotatably coupled along the locking shaft proximate to at least one of the right-hand threaded portion or the left-hand threaded portion and a bracing footing coupled with at least one of the workpiece body or the support plate. The bracing footing including a bracing fastener receiving opening.

### BACKGROUND

Housings at times enclose, retain, protect, or the like, sensitive internal components such as computer systems, electronic systems, mechanical systems, chemical systems, or a combination of systems. Sensitive internal components can be delicate and can be damaged when exposed to excess vibrations or movement. In some situations, low frequency vibrations, such as vibrations lower than approximately 10 hertz, damage the sensitive internal components.

External devices can be implemented to minimize the effect of vibrations on the systems that contain sensitive components. Some of these devices include vibration isolation systems, active control systems, or environmental control systems. In an example, a vibration isolation system can include a suspension system with a low resonant frequency that isolates the sensitive system from external vibration. For instance, a snubber can be used to retain and release the system according to the desired use. A snubber can control movement during abnormal conditions such as unpredicted movement or open or closure of systems. In other examples, snubbers are used in systems where components move freely when in a predictable, routine, or normal condition and then the system is restrained when subjected to unexpected, increased, or undesired conditions where an excess of vibration can be present.

In other examples, an active control system can be implemented to reduce the effects of vibrations on a sensitive system. An active control system can include sensors that detect vibrations and then activate actuators to generate opposing forces to approximately equalize or minimize effects of incoming vibrations.

Certain systems that can include sensitive components used in vehicles, aerospace systems, marine systems, military systems or the like. These systems can optionally be retained to not move at certain times, and then can be allowed to move at other times.

### SUMMARY

The described examples focus on a movement control locking mechanism designed to manage low-frequency vibration isolation systems. These systems can be used for protecting sensitive equipment from external vibrations which can disrupt their operation.

The movement control locking mechanism can be coupled with a workpiece, such as a cabinet, that houses sensitive components. The movement control locking mechanism can include a locking shaft including at least one threaded portion. In some examples, the at least one threaded portion includes a right-hand threaded portion and a left-hand threaded portion. The locking shaft can rotate, which in turn can move other components of the movement control locking mechanism to transition the movement control locking mechanism from an unlocked configuration to a braced configuration.

In examples, the movement control locking mechanism can includes a footing linkage. The footing linkage can include a bracing fastener rotatably coupled with the locking shaft and a bracing footing. The bracing footing can include a bracing footing receiving opening that faces the bracing fastener. For example, the bracing fastener, when the locking shaft is rotated, can move towards the bracing fastener receiving opening of the bracing footing. In an example, when the bracing fastener is positioned within the bracing footing receiving opening the movement control locking mechanism can secure the workpiece in a desired position.

The described examples can provide a comprehensive solution for managing low-frequency vibration isolation systems. The movement control system can use a combination of mechanical components, including locking shafts, bracing fasteners, and bracing footings, to brace the system in place. The movement control system can be designed to be versatile and can be used in various applications, including electronic devices such as defense systems, aerospace systems, marine systems or the like. By addressing the challenges of low-frequency vibrations and limited access, the described examples can offer a reliable and efficient way to protect sensitive equipment from external forces.

### BRIEF DESCRIPTION OF THE DRAWINGS

FIG. 1 illustrates an example of a workpiece and movement control mechanism according to at least one example of the present disclosure.

FIG. 2 illustrates an example of a workpiece movement confining system according at least one example of the present disclosure.

FIG. 3A illustrates an example of a cross section of movement confining system in an unlocked configuration according to at least one example of the present disclosure.

FIG. 3B illustrates an example of a cross section of a movement confining system in a braced configuration according to at least one example of the present disclosure.

FIGS. 4A and 4B illustrate an example of a reinforcing lock according to at least one example of the present disclosure.

FIGS. 5A and 5B illustrates an isometric view of example of a method for reducing a movement of a workpiece according to at least one example of the present disclosure.

### DETAILED DESCRIPTION

Sensitive components can be housed within a structure such as a cabinet, compartment, box, housing or the like (hereinafter a “workpiece”). For example, sensitive components can include electrical systems, computer systems, mechanical systems, chemical systems, a combination of systems, or the like. In some instances, the sensitive components can be damaged or made inoperable if subjected to vibrations outside of a threshold range. In another example, when a system containing sensitive components encounters vibrations, the components of the system can unintentionally operate.

In some examples, vibrations recognized by the workpiece can be reduced with external devices such as vibration isolation systems. Vibration isolation systems can include mechanical or electrical systems that are enabled when undesired vibration is recognized. The vibration isolation system can include active control systems that implement sensors when a vibration is detected. A communication received from the sensor can then activate actuators that can generate an opposing force to counter the incoming vibrations.

In another example, vibration isolators can include mechanical systems such as suspensions, springs or other mechanical devices that can isolate the workpiece from external vibrations. In some instances, the mechanical vibration isolator while reducing the effects of the vibration does not sufficiently reduce the effects from the vibration. For example, the workpiece, when subjected to vibrations, even with vibration isolators, can still shift location of the workpiece.

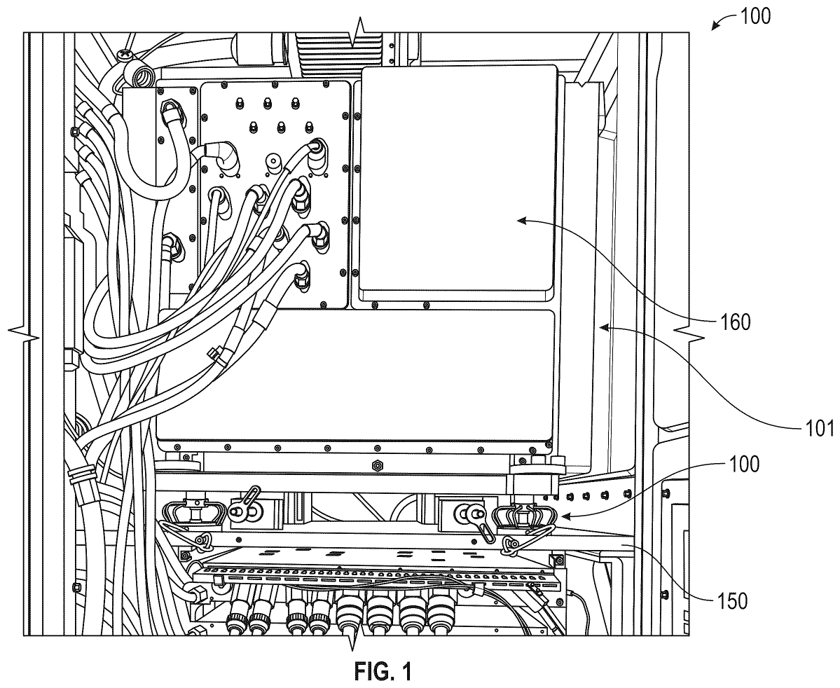

Illustrated in FIG. 1 is an example of an isolation lockout system 101 including a workpiece 160, a movement control mechanism 100 and a support plate 150. The movement control mechanism 100 can be implemented in addition to other vibration isolators or can be implemented as the primary means of reducing the effect of vibrations. The workpiece 160 can be a cabinet, compartment, box, housing or the like that retains (e.g., holds, stores) sensitive components. The sensitive components can include electrical systems, computer systems, mechanical system, chemical systems, or a combination of systems. The sensitive components can include elements that are easily damaged, destroyed or made inoperable if subjected to unintended vibrations. Unintended vibrations can include vibrations outside of a threshold range as dictated by the use. Unintended vibrations can also include vibrations that occur at an undesired time.

The movement control mechanism 100 can be coupled (e.g., connected, attached, associated, joined) with one or more of the workpiece 160 or the support plate 150. The movement control mechanism 100, in some examples, is coupled with the workpiece 160 at a position between the workpiece 160 and the support plate 150. The movement control mechanism 100 can be coupled with the workpiece 160 at other locations as dictated by the purpose and the environment surrounding the workpiece 160. The movement control mechanism 100 can be coupled with the workpiece 160 at locations relative to the workpiece 160 to reduce (e.g., minimize, isolate) vibration recognized by the workpiece 160.

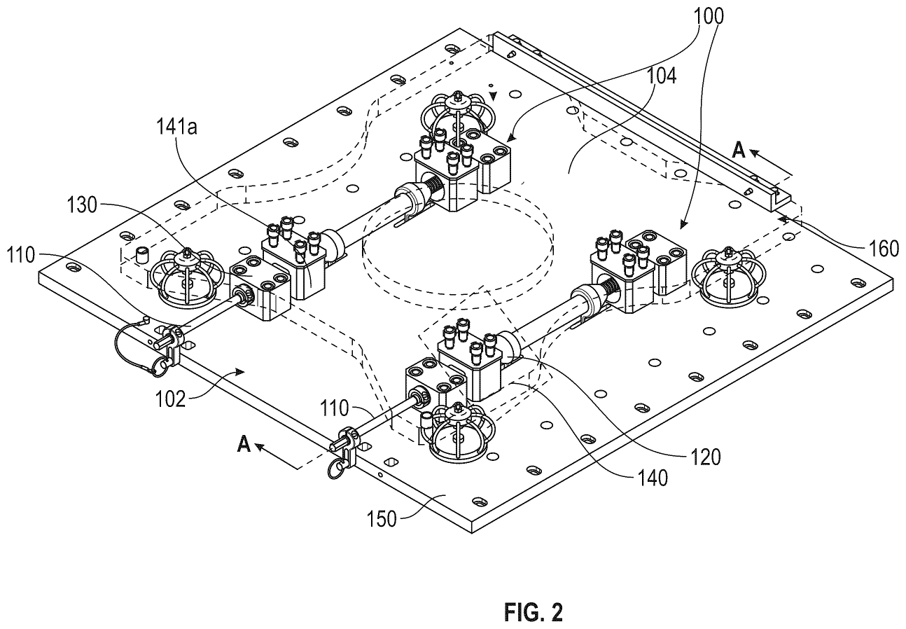

Illustrated in FIG. 2, is an isometric view of the isolation lockout system 101, as seen through the workpiece 160. Illustrated in FIG. 2 are two movement control mechanisms 100 each positioned to extend from a front portion 102 the isolation lockout system 101 to a rear portion 104 of the isolation lockout system 101. While illustrated as extending from a front portion 102 to a rear portion 104 of the isolation lockout system 101, the movement control mechanism 100 can be positioned in any orientation according to the environment in which the isolation lockout system 101 is positioned.

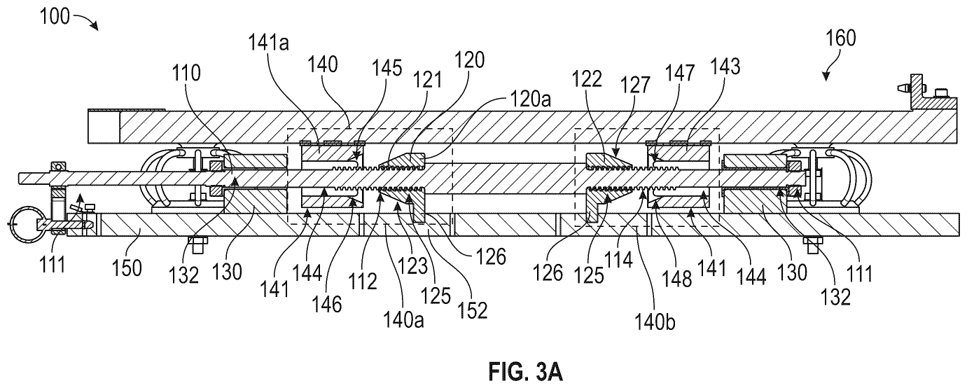

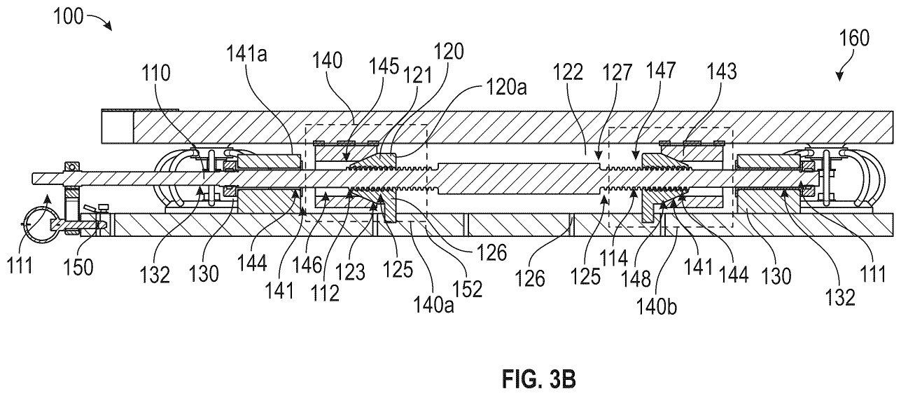

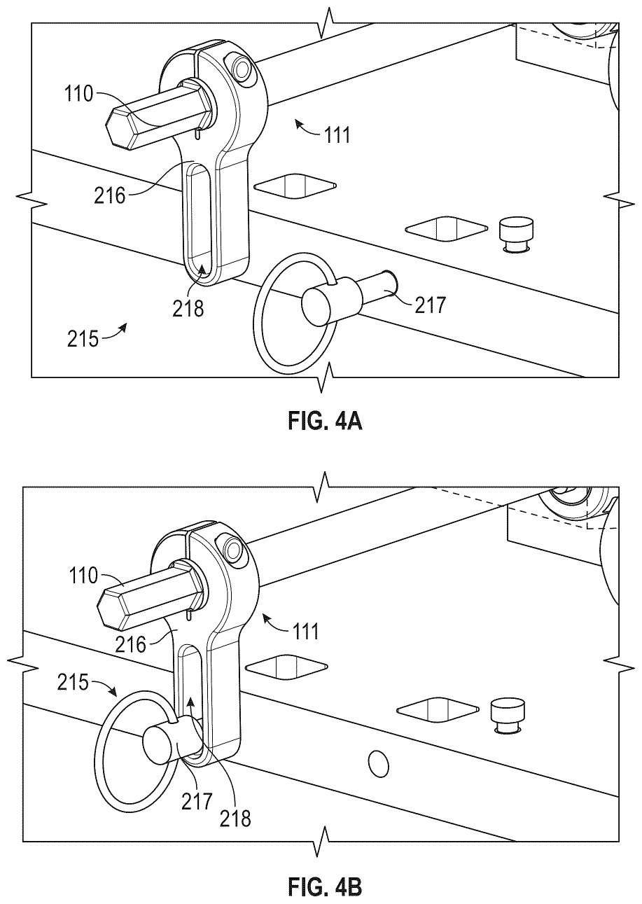

Each of the movement control mechanisms 100 can include one or more footing linkage 140 and a locking shaft 110. For example, one or more bracing footings can be coupled with at least one of the workpiece 160 or the support plate 150. The locking shaft 110 can be coupled with the support plate 150 and can extend through the one or more footing linkage 140 to brace the workpiece 160 in a desired position. For example, the locking shaft 110 can rotate within the one or more footing linkage 140 to transition between an unlocked configuration from a braced configuration, as discussed related to FIGS. 3A, 3B and FIGS. 4A, 4B.

The one or more footing linkage 140 can include at least a bracing footing 141 and a bracing fastener 120. The bracing footing 141 can cooperatively receive the bracing fastener 120 to brace the workpiece 160 and control the movement of the workpiece 160. In an example, the bracing fastener 120 received within the bracing footing 141 isolates the workpiece 160 from undesired vibrations.

FIGS. 3A and 3B are cross sections of the isolation lockout system 101 taken at A-A in FIG. 2. FIG. 3A is an example of a cross section taken at A-A when the movement control mechanism 100 is in an unlocked configuration. FIG. 3B is an example of a cross section of the movement control mechanism 100 when in a braced configuration. In an example, the isolation lockout system 101 includes the support plate 150 and the workpiece 160. The support plate 150 is, for example, positioned below the workpiece 160. However, the support plate 150 can be positioned relative to the workpiece 160 such that the movement control mechanism 100 can be coupled between the support plate 150 and the workpiece 160. For example, the support plate 150 and the workpiece 160 can be positioned to extend substantially vertically or at an angle relative to a horizontal axis of the environment in which the workpiece 160 is contained.

The locking shaft 110 can be coupled with the support plate 150 and extend relative to at least one of the support plate 150 or the workpiece 160. In an example, the locking shaft 110 extends approximately parallel to a longitudinal axis of the support plate 150. In another example, the locking shaft 110 extends approximately parallel to a lateral axis of the support plate 150. In an example, the locking shaft 110 is positioned relative to the workpiece 160 or the support plate 150 such that it is rotatably coupled. For example, the locking shaft 110 can be rotatably coupled with the support plate 150 such that the locking shaft 110 can be rotated by a user. For instance, a user can rotate, or initiate rotation of, the locking shaft 110 to repeatedly rotate 360 degrees or less. For example, the locking shaft 110 can rotate several times to engage a thread on the locking shaft 110.

The locking shaft 110 can include one or more threaded portions 125 spaced from an end portion 111 of the locking shaft 110. In an example, the one or more threaded portions 125 includes a first threaded portion 112 and a second threaded portion 114. For example, at least one of the one or more threaded portions 125 is a right-hand threaded portion. In another example, at least one of the one or more threaded portions 125 is a left-hand threaded portion. In yet another example, the locking shaft 110 includes two of the one or more threaded portions 125. The first threaded portion 112 can be a right-hand threaded portion and the second threaded portion 114 can be a left-hand threaded portion, as will be discuss further below.

The movement control mechanism 100 can also include one or more footing linkage 140. The one or more footing linkage 140 can include a bracing fastener 120 and a bracing footing 141. The one or more bracing footing 141 can be a stationary or static component of the one or more footing linkage 140 that can be coupled with one of the workpiece 160 or the support plate 150. The bracing fastener 120, for example, is a dynamic component of the movement control mechanism 100 that can translate from a position remote from the bracing footing 141 to a position in contact with the bracing footing 141.

In an example, the bracing footing 141 is coupled with the workpiece 160. The bracing footing 141 can be screwed, adhered, or otherwise fixed to the workpiece 160. The bracing footing 141 can include a passage 144 (e.g., through hole, tunnel, channel) that can rotatably receive and retain the locking shaft 110. For example, the bracing footing 141 can provide a passage 144 through which the locking shaft 110 extends towards and though the one or more threaded portions 125.

In an example, the bracing fastener 120 is rotatably coupled along the locking shaft 110 proximate to the one or more threaded portions 125. For example, the bracing fastener 120 has a complementary thread to engage with the one or more threaded portions 125. For instance, the bracing fastener 120 includes a complementary thread 121 to the first threaded portion 112 such as a right-hand thread or left-hand thread. The bracing fastener 120 can also be formed to have a tapered portion 123. The bracing fastener 120 can be positioned on the locking shaft 110 so the tapered portion 123 faces a bracing footing 141.

The bracing fastener 120 can include a translation guide protrusion 126 that extends towards the support plate 150. The translation guide protrusion 126 can be an additional retaining element of the movement control mechanism 100. For example, the translation guide protrusion 126 can extend into a translation guide track 152 formed in the support plate 150. The translation guide track 152 can be formed as an elongated recess (e.g., channel, opening, cavity) in the support plate 150. The translation guide track 152 can retain the translation guide protrusion 126 so the bracing fastener 120 does not rotate, or minimally rotates, when the bracing fastener 120 is, for example, moved from one orientation to another orientation. For example, the bracing fastener 120 does not move or only minimally moves in a lateral direction according to a width of the translation guide track 152. By not moving or only minimally moving, the bracing fastener 120 can be prevented from rotating unnecessarily. The translation guide track 152 can also extend from an internal portion of the support plate 150 to a position proximate to the first bracing footing 141a. The length of the translation guide track 152 can minimize or reduce the bracing fastener from being positioned too far away or too close to the bracing footing 141.

The bracing footing 141 can include a bracing fastener receiving opening 145. The bracing fastener receiving opening 145 can be a recess (e.g., indentation, cavity, opening) that extends from an outer surface of the bracing footing 141 towards the interior of the bracing footing 141. The bracing fastener receiving opening can be sized and shaped to receive an engaging portion, such as the tapered portion 123 of the bracing fastener 120.

The bracing fastener receiving opening 145 can define a bracing fastener receiving junction 146 as the portion of the bracing footing 141 that engage with the bracing fastener 120. The bracing fastener receiving junction 146 can include a profile complementary to the profile of the portion of the bracing fastener 120 that fits with the bracing fastener receiving opening 145. For instance, the tapered portion 123 can engage with and be positioned within the bracing fastener receiving opening 145 at the bracing fastener receiving junction 146. For example, the bracing fastener receiving opening 145 can be inwardly tapered to receive the tapered portion 123.

In an example, the movement control mechanism 100 includes a first footing linkage 140a and a second footing linkage 140b. For example, the first footing linkage 140a and the second footing linkage 140b are coupled with the locking shaft 110. For instance, the locking shaft 110 can include a first threaded portion 112 and a second threaded portion 114 each positioned remotely from the end portion 111 of the locking shaft 110. The first footing linkage 140a and the second footing linkage 140b can be coupled along the locking shaft 110 such that the first footing linkage 140a can be positioned proximate to the first threaded portion 112 and the second footing linkage 140b can be positioned proximate to the second threaded portion 114.

The second threaded portion 114 of the locking shaft 110 can have a thread that can be oriented in an opposite to the first threaded portion 112. For example, if the first threaded portion 112 is a right-hand thread the second threaded portion 114 is a left-hand thread. The thread of the one or more threaded portions 125 can also be reversed such that the first threaded portion 112 can be a left-hand thread and the second threaded portion 114 can be a right-hand thread.

The first footing linkage 140a can include the bracing fastener 120 discussed previously as the first bracing fastener 120a. The first bracing fastener 120a can be rotatably coupled along the locking shaft 110 proximate to the first threaded portion 112. Similar to the bracing fastener 120 discussed previously, the first bracing fastener 120a can include a tapered portion 123 that faces the first bracing footing 141a. The first bracing footing 141a can include a first bracing fastener receiving opening 145 that can be formed to receive and retain the first bracing fastener 120. In an example, the first bracing footing 141a includes a first bracing fastener receiving junction 146 as the portion of the first bracing fastener receiving opening 145 that engages with the first bracing fastener 120a. For example, bracing fastener receiving junction 146 can have a complementary profile to the tapered portion 123.

In an example, movement control mechanism 100 includes a second footing linkage 140b. The second footing linkage 140b can include a second bracing fastener 122 and a second bracing footing 143. The second bracing fastener 122 can be rotatably coupled along the locking shaft 110 proximate to a second threaded portion 114. In an example, the second bracing fastener 122 includes a second tapered portion 127 that is positioned on the locking shaft 110 to face a second bracing footing 143. The second bracing footing 143 can include a second bracing fastener receiving opening 147. The second bracing fastener receiving opening 147 can include a second bracing fastener receiving junction 148. For instance, the second bracing fastener receiving junction 148 can have a complementary profile to the second tapered portion 127.

The movement control mechanism 100 can also include one or more locking shaft seat 130. In an example, the one or more locking shaft seat 130 is coupled with the support plate 150. In another example, the one or more locking shaft seat 130 is coupled with the workpiece 160. The one or more locking shaft seat 130 can be positioned on one of the support plate 150 and the workpiece 160 and coupled with the locking shaft 110 between the end portion 111 and the bracing footing 141. For example, the movement control mechanism 100 can include the one or more locking shaft seat 130 positioned between the end portion 111 of the locking shaft 110 and the first bracing footing 141a and a second of the one or more locking shaft seat 130 positioned between the second bracing footing 143 and an opposing end portion 111.

Each of the one or more locking shaft seat 130 can include a through hole 132. The through hole 132 can be formed to receive the locking shaft 110. For example, the through hole 132 is formed to retain the locking shaft 110. In a further example, the through hole 132 is formed to rotatably retain the locking shaft 110. The one or more locking shaft seat 130 can be a form that can receive the locking shaft 110 and can also allow the locking shaft 110 to rotate. For instance, the through hole 132 can be completely enclosed or partially open, such as a “U” shape or a “C” shape. The one or more locking shaft seat 130 can support the locking shaft 110 during operation of the movement control mechanism 100 such as transitioning from an unlocked configuration to a braced configuration or from a braced configuration to an unlocked configuration.

In an example, the one or more footing linkage 140 can transition from an unlocked configuration, as illustrated in FIG. 3A, to a locked configuration, as illustrated in FIG. 3B. In the unlocked configuration illustrated in FIG. 3A, the bracing fastener 120 can be spaced from the bracing first bracing footing 141a. In an example of the unlocked configuration, the first bracing fastener 120a and the second bracing fastener 122 can both be spaced from the respective first bracing footing 141a and the second bracing footing 143. For example, the first bracing fastener 120a is threadingly coupled with the locking shaft 110 relative to the first threaded portion 112 such as a right-hand thread and the second bracing fastener 122 is threadingly coupled relative to the locking shaft 110 with a second threaded portion 114 such as a left-hand thread.

In an example, the one or more footing linkage 140 can include a braced configuration, as illustrated in FIG. 3B. In a braced configuration, at least a portion of the bracing fastener 120 can be positioned within the bracing fastener receiving opening 145. For example, the bracing fastener 120 includes the tapered portion 123 and the bracing fastener receiving opening 145 includes a bracing fastener receiving junction 146 having a complementary profile to the tapered portion 123. In the braced configuration, at least a portion of the tapered portion 123 can be positioned within to the bracing fastener receiving opening 145. In an example, at least a portion of the tapered portion 123 is in contact or in close proximity (e.g., a few millimeters or less from the bracing fastener receiving junction) with at least a portion of the bracing fastener receiving junction 146. The braced configuration can lock (e.g., retain, brace, confine) the movement control mechanism 100 such that the workpiece 160 can be isolated from unwanted vibrations.

In some examples, a secondary device can be used to further secure the movement control mechanism 100. Illustrated in FIG. 4A and FIG. 4B are examples of a secondary locking mechanism such as a reinforcing lock 215. The reinforcing lock 215 be coupled with the locking shaft 110. For example, the reinforcing lock 215 can be coupled with an end portion 111 of the locking shaft 110. The reinforcing lock 215 can assist with preventing unwanted rotation of the locking shaft 110.

The reinforcing lock 215 can include a receiving clasp 216 and a reinforcing key 217. For example, the receiving clasp 216 can be coupled with the locking shaft 110. The receiving clasp 216 can be rotatably coupled with the locking shaft 110. For example, the receiving clasp 216 have a released configuration where the receiving clasp 216 can be in a first position and a retained configuration where the receiving clasp 216 is in a second position. In the second position the receiving clasp 216 can be position for the reinforcing key 217 to be coupled with both the receiving clasp 216 and the support plate 150.

The reinforcing key 217 in some examples can be a pin that fits within a clasp receiving opening 218. In an example, the clasp receiving opening 218 is aligned with a hole, recess, indentation, or the like in the support plate 150 when the receiving clasp 216 is in the second position. For instance, the receiving clasp 216 in the second position allows for insertion of the reinforcing key 217 through the opening 218 and into a keyhole in the support plate 150. When the reinforcing key 217 is, for example, positioned through the opening 218 undesired rotation of the locking shaft 110 can be reduced. When the reinforcing key 217 is removed from the opening 218 the locking shaft 110 can rotate to, for example, transition the movement control mechanism 100 from a braced configuration to an unlocked configuration or visa versa.

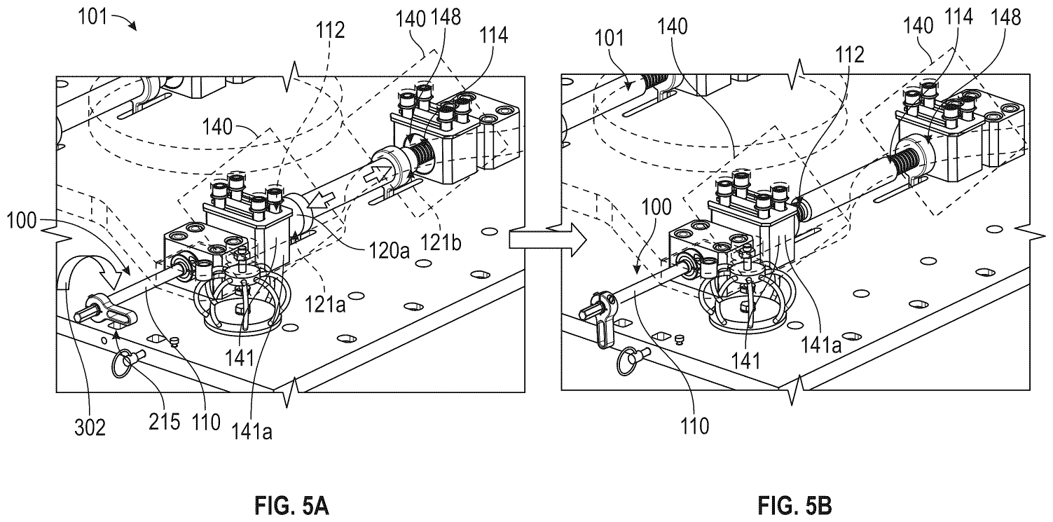

Illustrated in FIGS. 5A and 5B is an example of the transition of the movement control mechanism 100 from an unlocked configuration to a braced configuration. For example, the movement control mechanism 100, including the locking shaft 110 is positioned proximate to the support plate 150 and the workpiece 160. In an example, the movement control mechanism 100 is positioned between the support plate 150 and the workpiece 160. In an example, the movement control mechanism 100 includes two of the one or more footing linkage 140. The first bracing footing 141a and the second bracing footing 143 can be coupled with the workpiece 160 and the one or more locking shaft seat 130 can be coupled with the support plate 150.

In a method of reducing the movement recognized by the workpiece when subjected to unwanted vibrations, method can include, for example, rotating the locking shaft 110 as indicated by arrow 302 in FIG. 5A. In the example of FIGS. 5A and 5B, the locking shaft 110 can include the first threaded portion 112 and the second threaded portion 114 spaced from the first threaded portion 112. For instance, the first threaded portion 112 is a right-hand thread and the second threaded portion 114 is a left-hand thread. The locking shaft 110 can include a first bracing fastener 120a and a second bracing fastener 122. In an example, the first bracing fastener 120a has a complementary thread 121a to the first threaded portion 112 and the second bracing fastener 122 has a complementary thread 121b to the second threaded portion 114. For instance, the complementary thread 121 of the first bracing fastener 120a is opposite to the complementary thread 121 of the second bracing fastener 122.

In one example, the reinforcing lock 215 is coupled with an end portion 111 of the locking shaft 110 in a released configuration. In the released configuration, the reinforcing lock 215 does not inhibit rotation of the locking shaft 110. A user can rotate the locking shaft 110 from the end portion 111.

The rotation of the locking shaft 110 can transition the one or more footing linkage 140 from the unlocked configuration illustrated in FIG. 5A to the locked configuration illustrated in FIG. 5B. As illustrated in FIG. 5A, in the unlocked configuration the bracing fastener 120 can be spaced from the bracing footing 141. For example, the first bracing fastener 120a is spaced from the first bracing footing 141a and the second bracing fastener 122 is spaced from the second bracing footing 143.

As the locking shaft 110 is rotated, the rotation can be translated to the bracing fastener 120. The rotation of the locking shaft 110 can advance the bracing fastener 120 along the one or more threaded portions 125 to bring the bracing fastener 120 towards the bracing footing 141. Rotation of the locking shaft 110 can continue until the bracing fastener 120 is retained (e.g., partially retained or completely retained) within the bracing fastener receiving opening 145. In an example, rotation of the locking shaft 110 can translate movement to both of the first bracing fastener 120a and the second bracing fastener 122 so the first bracing fastener 120a and the second bracing fastener 122 are advanced towards the first bracing fastener receiving opening 145 and the second bracing fastener receiving opening 147, respectively. The first bracing fastener 120a and the second bracing fastener 122 can be advanced until received within the first bracing fastener receiving opening 145 and the second bracing fastener receiving opening 147, respectively.

In an example, the bracing fastener 120 includes a tapered portion 123 that is received within the bracing fastener receiving opening 145. The bracing fastener 120 can be advanced until the tapered portion 123 is received in (e.g., engaged, coupled, in communication) the bracing fastener receiving opening 145. The bracing fastener receiving opening 145 can include the bracing fastener receiving junction 146 such that the bracing fastener 120 can be advanced towards the bracing fastener receiving opening 145 the tapered portion 123 can be received to be in communication with the bracing fastener receiving junction 146.

When the first bracing fastener 120a and the second bracing fastener 122 are each received within the first bracing fastener receiving opening 145 and the second bracing fastener receiving opening 147, the workpiece 160 can be isolated or braced to reduce the effect of vibrations experienced by the workpiece 160. In an example, having both the first bracing fastener 120a and the second bracing fastener 122 in a braced configuration reduces longitudinal movement (as taken along a longitudinal axis of the locking shaft). Longitudinal movement of the locking shaft 110 can be reduced by the opposite facing first bracing fastener 120a and the second bracing fastener 122. The tapered portion 123 can reduce the lateral and vertical movement of the movement control mechanism 100. The tapered portion 123 engaged with the bracing fastener receiving opening 145 and the bracing fastener receiving junction 146 can retain the tapered portion 123 in place with minimal, if any, space for movement.

In an example, the movement control mechanism 100 can be further secured to reduce or minimize movement of the workpiece 160 with the reinforcing lock 215. For example, in the released configuration, the receiving clasp 216 is not engaged with the reinforcing key 217 and when the one or more footing linkage 140 is in the braced configuration, the receiving clasp 216 can be positioned to the retained configuration. In the retained configuration, the reinforcing key 217 can be coupled with the receiving clasp 216 to further reduce instances of the locking shaft 110 rotating.

### Aspects

Aspect 1 can include subject matter such as a movement control locking mechanism comprising: a locking shaft including a right-hand threaded portion and a left-hand threaded portion; a first bracing fastener engaged with the right-hand threaded portion; a second bracing fastener with the left-hand threaded portion; a first bracing footing including a first bracing fastener receiving opening; and a second bracing footing including second bracing fastener receiving opening; wherein the first bracing fastener receiving opening faces the second bracing fastener receiving opening; wherein the first bracing fastener is configured to move towards the first bracing fastener receiving opening and the second bracing fastener is configured to move towards the second bracing fastener receiving when the locking shaft is rotated in a first direction.
Aspect 2 can include, or can optionally be combined with the subject matter of Aspect 1, to optionally include the first bracing fastener is threadingly engaged with the right-hand threaded portion; and the second bracing fastener is threadingly engaged with the left-hand threaded portion.
Aspect 3 can include, or can optionally be combined with the subject matter of one or any combination of Aspects 1 or 2 to optionally include one or more locking shaft seat having a through hole extending through the one or more locking shaft seat; wherein the through hole is configured to support the locking shaft.
Aspect 4 can include, or can optionally be combined with the subject matter of one or any combination of Aspects 1 to 3 to optionally include a first locking shaft seat and a second locking shaft seat; wherein the first bracing footing is positioned between the first locking shaft seat and the first bracing fastener; wherein the second bracing footing is positioned between the second locking shaft seat and the second bracing fastener.
Aspect 5 can include, or can optionally be combined with the subject matter of one or any combination of Aspects 1 to 4 to optionally include the first bracing fastener includes a tapered portion; and the first bracing footing includes a first bracing fastener receiving junction having a first fastener receiving junction profile complementary to the profile of the tapered portion.
Aspect 6 can include, or can optionally be combined with the subject matter of one or any combination of Aspects 1 to 5 to optionally include a reinforcing lock coupled with an end portion of the locking shaft, the receiving lock including: a receiving clasp coupled with the end portion of the locking shaft; and a reinforcing key configured to engage with the receiving clasp.
Aspect 7. The movement control locking mechanism of Aspect 1, including a locking shaft seat configured to receive the locking shaft; wherein the locking shaft extends through the locking shaft seat, the first bracing footing and the first bracing fastener; wherein at least a portion of right-hand threaded portion is positioned within the first bracing footing; and the first bracing fastener is threadingly engaged with the right-hand threaded portion.
Aspect 8 can include subject matter such as a workpiece movement confining system comprising: a workpiece body; a support plate positioned relative to the workpiece body; a locking shaft including a threaded portion, the locking shaft positioned between the workpiece body and the support plate; and at least one footing linkage coupled along the locking shaft including: a bracing fastener rotatably coupled along the locking shaft proximate to the threaded portion; and a bracing footing coupled with at least one of the workpiece body or the support plate, the bracing footing including a bracing fastener receiving opening; wherein the bracing fastener is configured to translate from an unlocked configuration to a braced configuration; wherein in the unlocked configuration the bracing fastener is spaced from the bracing fastener opening and in the braced configuration the bracing fastener is positioned within the bracing fastener receiving opening; and wherein the locking shaft is configured to rotate to transition the bracing fastener from the unlocked configuration to the braced configuration.
Aspect 9 can include, or can optionally be combined with the subject matter of one or any combination of Aspect 8 to optionally include a first footing linkage coupled along the locking shaft including: a first bracing fastener rotatably coupled along the locking shaft proximate to the threaded portion; and a first bracing footing coupled with at least one of the workpiece body or the support plate, the first bracing footing including a first bracing fastener receiving opening; and a second footing linkage spaced from the first footing linkage coupled along the locking shaft including: a second bracing fastener rotatably coupled along the locking shaft proximate to the threaded portion; and a second bracing footing coupled with at least one of the workpiece body or the support plate, the second bracing footing including a second bracing fastener receiving opening; wherein the locking shaft is configured to rotate and rotation of the locking shaft is configured to transition both the first bracing footing linkage and the second bracing footing linkage from an unlocked configuration to a braced configuration; wherein in the unlocked configuration first bracing fastener and the second bracing fastener is spaced from the first bracing fastener opening and the second bracing fastener opening and in the braced configuration the first bracing fastener is positioned within the first bracing fastener receiving opening and the second bracing fastener is positioned within the second bracing fastener opening.
Aspect 10 can include, or can optionally be combined with the subject matter of one or any combination of Aspects 8 or 9 to optionally include the workpiece body includes an electronic device.
Aspect 11 can include, or can optionally be combined with the subject matter of one or any combination of Aspects 8-10 to optionally include a first locking shaft seat and a second locking shaft each coupled with the support plate and each including a through hole configured to retain the locking shaft, wherein the support plate is positioned under the workpiece body; wherein the locking shaft extends through the first locking shaft seat, a first footing linkage, a second footing linkage and the second locking shaft seat.
Aspect 12 can include, or can optionally be combined with the subject matter of one or any combination of Aspects 8-11 to optionally include a first bracing fastener is threadingly engaged with a right-hand threaded portion on the locking shaft and a second bracing fastener is threadingly engaged with a left-hand threaded portion on the locking shaft.
Aspect 13 can include, or can optionally be combined with the subject matter of one or any combination of Aspects 8-12 to optionally include a tapered portion extending from the bracing fastener towards the bracing footing; and the bracing footing including a bracing fastener receiving junction having a fastener receiving junction profile complementary to the profile of the tapered portion.
Aspect 14 can include, or can optionally be combined with the subject matter of one or any combination of Aspects 8-13 to optionally include the bracing fastener includes a translation guide protrusion; and the support plate includes a translation guide track configured to retain the translation guide protrusion.
Aspect 15 can include, or can optionally be combined with the subject matter of one or any combination of Aspects 8-14 to optionally include a locking shaft seating coupled with the support plate; and wherein the bracing footing is coupled with the workpiece; wherein the locking shaft extends through the locking shaft seating, the bracing footing, and the bracing fastener.
Aspect 16 can include, or can optionally be combined with the subject matter of one or any combination of Aspects 8-15 to optionally include a reinforcing lock positioned proximate to an end portion of the locking shaft, the reinforcing lock having a receiving clasp and a reinforcing key; wherein the reinforcing key is configured to be coupled with the receiving clasp and the support plate.
Aspect 17 can include, or can optionally be combined with the subject matter of one or any combination of Aspects 8-16 to optionally include the reinforcing lock is configured to transition from a released configuration to a retained configuration; wherein in the released configuration the reinforcing key is remotely positioned from the receiving clasp and in the retained configuration the reinforcing key is positioned within the receiving clasp; wherein the reinforcing lock transitions from the released configuration to the retained configuration when the footing linkage transitions from the unlocked configuration to the braced configuration.
Aspect 18 can include subject matter such as a method of reducing movement of a workpiece comprising: rotating a locking shaft including at least one of a right-hand threaded portion and a left-hand threaded portion, the locking shaft positioned proximate to a workpiece body and a support plate; transitioning at least one footing linkage from an unlocked configuration to a braced configuration, the at least one footing linkage including: a bracing fastener rotatably coupled along the locking shaft proximate to at least one of the right-hand threaded portion or the left-hand threaded portion; and a bracing footing coupled with at least one of the workpiece body or the support plate, the bracing footing including a bracing fastener receiving opening; wherein transitioning the footing linkage from the unlocked configuration to the locked configuration includes: rotating the locking shaft rotatably received within the bracing fastener and the bracing footing; translating rotation of the locking shaft to the bracing fastener; and advancing the bracing fastener towards the bracing footing until the bracing fastener is received within the bracing fastener receiving opening.
Aspect 19 can include, or can optionally be combined with the subject matter of Aspect 18 to optionally include the at least one footing linkage includes a first footing linkage and a second footing linkage spaced from the first footing linkage, the method includes: rotating the locking shaft rotatably received within the first footing linkage and the second footing linkage; translating rotation of the locking shaft advances a first bracing fastener towards a first bracing footing and a second bracing fastener towards a second bracing footing; wherein the first bracing fastener is threadingly coupled with a right-hand thread on the locking shaft and the second bracing fastener is threadingly coupled with a left-hand thread on the locking shaft.
Aspect 20 can include, or can optionally be combined with the subject matter of one or any combination of Aspects 18 or 19 to optionally include the bracing fastener includes a tapered portion and the bracing footing includes the bracing fastener receiving opening having a complementary profile to the tapered portion.

The above description includes references to the accompanying drawings, which form a part of the detailed description. The drawings show, by way of illustration, specific embodiments in which the disclosed concepts can be practiced. These embodiments are also referred to herein as “aspects” or “examples.” Such aspects or example can include elements in addition to those shown or described. However, the description also contemplates aspects or examples in which only those elements shown or described are provided. Moreover, the description also contemplates aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular,” “round,” or “square”, are not intended to require absolute mathematical precision, unless the context indicates otherwise.

Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, subject matter may lie in less than all features of a particular disclosed embodiment. Thus, the following claims are hereby incorporated into the Detailed Description as aspects, examples, or embodiments, with each claim standing on its own as a separate embodiment, and it is contemplated that such embodiments can be combined with each other in various combinations or permutations. The scope of the disclosed concepts should be determined with reference to the appended claims, along with the full scope of equivalents to which such claims are entitled.

What is claimed is:

1. A movement control locking mechanism comprising:
a locking shaft including a right-hand threaded portion and a left-hand threaded portion;
a first bracing fastener engaged with the right-hand threaded portion;
a second bracing fastener with the left-hand threaded portion;
a first bracing footing including a first bracing fastener receiving opening; and
a second bracing footing including second bracing fastener receiving opening;
wherein the first bracing fastener receiving opening faces the second bracing fastener receiving opening;
wherein the first bracing fastener is configured to move towards the first bracing fastener receiving opening and the second bracing fastener is configured to move towards the second bracing fastener receiving when the locking shaft is rotated in a first direction.

2. The movement control locking mechanism of claim 1, wherein the first bracing fastener is threadingly engaged with the right-hand threaded portion; and
the second bracing fastener is threadingly engaged with the left-hand threaded portion.

3. The movement control locking mechanism of claim 1, including one or more locking shaft seat having a through hole extending through the one or more locking shaft seat;
wherein the through hole is configured to support the locking shaft.

4. The movement control locking mechanism of claim 1 including, a first locking shaft seat and a second locking shaft seat;
wherein the first bracing footing is positioned between the first locking shaft seat and the first bracing fastener;
wherein the second bracing footing is positioned between the second locking shaft seat and the second bracing fastener.

5. The movement control locking mechanism of claim 1, wherein the first bracing fastener includes a tapered portion; and
the first bracing footing includes a first bracing fastener receiving junction having a first fastener receiving junction profile complementary to the profile of the tapered portion.

6. The movement control locking mechanism of claim 1 including, a reinforcing lock coupled with an end portion of the locking shaft, the receiving lock including:
a receiving clasp coupled with the end portion of the locking shaft; and
a reinforcing key configured to engage with the receiving clasp.

7. The movement control locking mechanism of claim 1, including a locking shaft seat configured to receive the locking shaft;
wherein the locking shaft extends through the locking shaft seat, the first bracing footing and the first bracing fastener;
wherein at least a portion of right-hand threaded portion is positioned within the first bracing footing; and
the first bracing fastener is threadingly engaged with the right-hand threaded portion.

8. A workpiece movement confining system comprising:
a workpiece body;
a support plate positioned relative to the workpiece body;
a locking shaft including a threaded portion, the locking shaft positioned between the workpiece body and the support plate; and
at least one footing linkage coupled along the locking shaft including:
a bracing fastener rotatably coupled along the locking shaft proximate to the threaded portion; and
a bracing footing coupled with at least one of the workpiece body or the support plate, the bracing footing including a bracing fastener receiving opening;
wherein the bracing fastener is configured to translate from an unlocked configuration to a braced configuration;
wherein in the unlocked configuration the bracing fastener is spaced from the bracing fastener opening and in the braced configuration the bracing fastener is positioned within the bracing fastener receiving opening; and
wherein the locking shaft is configured to rotate to transition the bracing fastener from the unlocked configuration to the braced configuration.

9. The workpiece movement confining system of claim 8, including:
a first footing linkage coupled along the locking shaft including:
a first bracing fastener rotatably coupled along the locking shaft proximate to the threaded portion; and
a first bracing footing coupled with at least one of the workpiece body or the support plate, the first bracing footing including a first bracing fastener receiving opening; and
a second footing linkage spaced from the first footing linkage coupled along the locking shaft including:
a second bracing fastener rotatably coupled along the locking shaft proximate to the threaded portion; and
a second bracing footing coupled with at least one of the workpiece body or the support plate, the second bracing footing including a second bracing fastener receiving opening;
wherein the locking shaft is configured to rotate and rotation of the locking shaft is configured to transition both the first bracing footing linkage and the second bracing footing linkage from an unlocked configuration to a braced configuration;
wherein in the unlocked configuration first bracing fastener and the second bracing fastener is spaced from the first bracing fastener opening and the second bracing fastener opening and in the braced configuration the first bracing fastener is positioned within the first bracing fastener receiving opening and the second bracing fastener is positioned within the second bracing fastener opening.

10. The workpiece movement confining system of claim 8, wherein the workpiece body includes an electronic device.

11. The workpiece movement confining system of claim 8 including, a first locking shaft seat and a second locking shaft each coupled with the support plate and each including a through hole configured to retain the locking shaft,
wherein the support plate is positioned under the workpiece body;
wherein the locking shaft extends through the first locking shaft seat, a first footing linkage, a second footing linkage and the second locking shaft seat.

12. The workpiece movement confining system of claim 8 wherein a first bracing fastener is threadingly engaged with a right-hand threaded portion on the locking shaft and a second bracing fastener is threadingly engaged with a left-hand threaded portion on the locking shaft.

13. The workpiece movement confining system of claim 8 the footing linkage includes:
a tapered portion extending from the bracing fastener towards the bracing footing; and
the bracing footing including a bracing fastener receiving junction having a fastener receiving junction profile complementary to the profile of the tapered portion.

14. The workpiece movement confining system of claim 8 wherein the bracing fastener includes a translation guide protrusion; and
the support plate includes a translation guide track configured to retain the translation guide protrusion.

15. The workpiece movement confining system of claim 8 including a locking shaft seating coupled with the support plate; and
wherein the bracing footing is coupled with the workpiece;
wherein the locking shaft extends through the locking shaft seating, the bracing footing, and the bracing fastener.

16. The workpiece movement confining system of claim 8 including a reinforcing lock positioned proximate to an end portion of the locking shaft, the reinforcing lock having a receiving clasp and a reinforcing key;
wherein the reinforcing key is configured to be coupled with the receiving clasp and the support plate.

17. The workpiece movement confining system of claim 16, wherein the reinforcing lock is configured to transition from a released configuration to a retained configuration;
wherein in the released configuration the reinforcing key is remotely positioned from the receiving clasp and in the retained configuration the reinforcing key is positioned within the receiving clasp;
wherein the reinforcing lock transitions from the released configuration to the retained configuration when the footing linkage transitions from the unlocked configuration to the braced configuration.

18. A method of reducing movement of a workpiece comprising:
rotating a locking shaft including at least one of a right-hand threaded portion and a left-hand threaded portion, the locking shaft positioned proximate to a workpiece body and a support plate;
transitioning at least one footing linkage from an unlocked configuration to a braced configuration, the at least one footing linkage including:
a bracing fastener rotatably coupled along the locking shaft proximate to at least one of the right-hand threaded portion or the left-hand threaded portion; and
a bracing footing coupled with at least one of the workpiece body or the support plate, the bracing footing including a bracing fastener receiving opening;
wherein transitioning the footing linkage from the unlocked configuration to the locked configuration includes:
rotating the locking shaft rotatably received within the bracing fastener and the bracing footing;
translating rotation of the locking shaft to the bracing fastener; and
advancing the bracing fastener towards the bracing footing until the bracing fastener is received within the bracing fastener receiving opening.

19. The method of reducing movement of the workpiece of claim 18 wherein the at least one footing linkage includes a first footing linkage and a second footing linkage spaced from the first footing linkage, the method includes:
rotating the locking shaft rotatably received within the first footing linkage and the second footing linkage;
translating rotation of the locking shaft advances a first bracing fastener towards a first bracing footing and a second bracing fastener towards a second bracing footing;
wherein the first bracing fastener is threadingly coupled with a right-hand thread on the locking shaft and the second bracing fastener is threadingly coupled with a left-hand thread on the locking shaft.

20. The method of reducing movement of the workpiece of claim 18, wherein the bracing fastener includes a tapered portion and the bracing footing includes the bracing fastener receiving opening having a complementary profile to the tapered portion.
